(19) United States
(12) Patent Application Publication
(10) Pub. No.: US 2008/0109491 A1
(43) Pub. Date: May 8, 2008

(54) METHOD AND SYSTEM FOR MANAGING REPUTATION PROFILE ON ONLINE COMMUNITIES

(75) Inventor: Jitendra Gupta, Los Altos, CA (US)

Correspondence Address: LOUIS VENTRE, JR, 2483 OAKTON HILLS DRIVE, OAKTON, VA, 22124-1530, US

(73) Assignee: SEZWHO INC., Los Altos, CA (US)

(21) Appl. No.: 11/934,756

(22) Filed: Nov. 3, 2007

Related U.S. Application Data
(60) Provisional application No. 60/856,673, filed on Nov. 3, 2006.

(51) Int. Cl. G06F 17/30

(52) U.S. Cl. 707/104.1; 707/E17.009

(57) ABSTRACT

A method and a system for evaluating the quality of a contribution made by a user in a distributed online community framework are disclosed. The quality of contribution is assessed by creating a reputation profile of the user across multiple online communities. The reputation profile contains a reputation score indicating the credibility of the user, user identification information, user participation statistics and user contribution information. Such reputation score is calculated based on the feedback provided by other users for the contribution made by the user. The system also allows maintaining and publishing a unique reputation profile across the distributed online communities. Maintaining the reputation profiles incentivizes users to contribute better quality content. This improves the overall quality of the community discourse.

### FIELD OF INVENTION

The present invention relates to a reputation management system for a user in an online community. More specifically, it relates to a method and a system for managing the reputation profile of a user across various online communities where the user participates.

### BACKGROUND OF THE INVENTION

The surge in the use of internet has led to increased interaction between people over the online medium. Several online communities are now available over the Internet where people share experiences, information and opinion.

The internet based networks include online communities where people discuss and present their opinions on various issues, share knowledge, find new friends (or partners, clients etc), pursue their interests like business, games and the like. This content generated by users while sharing of information on online communities is also referred to as community generated content.

A user in an online community typically creates his/her profile by registering on the online community website or providing an identification attribute that can be used for authentication like e-mail. Thus a unique profile is created for each user in an online community that may be used to fetch information about the user. The profile can have many attributes associated with it like name, contact number, address, email, album, interests of the individual and likes. The profile is maintained locally on the online community and is updated regularly.

However, the quality of community generated content is sometimes bad given the absence of any mechanism for authenticating a user and his/her background. The users of online communities are often geographically distributed and the time of interaction between users is limited. The only identifying criterion for authenticating a user is the email address or other such identifying attribute and there is no mechanism for establishing the credibility of a user in an online community.

The credibility of a user is usually measured by his/her reputation in the community that the user participates in. Reputation of an individual is built over time depending on the individual's behavior in the community. Reputation plays an important role in determining the credibility of any work produced by an individual. Reputation built on previous acts of an individual helps people in the community to predict the quality of work of the individual. In an internet-based networking framework, reputation becomes even more critical, because in most cases there is no direct interaction among the users in a web environment.

Some online communities have tried to implement a system for managing reputations of users to improve the quality of community generated content. For example some online communities have tried to place a system where a user can write testimonial or rate another user in the online community. But these credibility assessment systems are subjective in nature and lack any uniform way of assessing credibility of the user generated content.

Some online communities have tried to implement rating or ranking based systems in online communities for effectively managing the reputation of a user. US patent application number 20060042483 titled “Method and system for reputation evaluation of online users in a social networking scheme” describes a method and system for evaluating the rank or reputation of a user in social networking framework.

Typically, such reputation management systems have been designed by YAHOO!, GOOGLE, SLASHDOT, EBAY, AMAZON.COM and DIGG. These systems keep track of all the online contributions made by the user on the online community and provide a way in which users can rate each others' contribution to the online community. In order to measure user's contributions, these systems provide a reputation score for the user based on which the credibility of the user may be determined. For example, EBAY provides an online community for commercial interactions like selling and buying. The users in EBAY are buyers and sellers of goods and services. A reputation management system provided by EBAY assigns a reputation score to a user so that a seller having higher reputation score is considered more credible compared to another seller with lower reputation score.

However all these conventional reputation management systems are localized i.e. these systems do not provide a service to manage user reputation across different online communities. Another problem with conventional reputation management systems is that the criteria for determining the reputation of an individual are very simplistic. These systems do not take into account important criteria for calculating the reputation score like reputation of the rater rating the contribution of a user. Further, such systems do not provide domain specific reputation score. Thus, a person might have very high overall reputation score even when he is contributing in only one specific domain. So an expert in the field of law would also be considered an expert in totally unrelated field like farming. Another limitation associated with conventional reputation management systems is that they don't use the reputation score to predict the quality of contribution from a user. This limits the incentives for the users to participate in the community. These systems also do not allow for ranking and sorting of the contributions based on their quality. While these systems may be suitable for the particular purpose for which they are designed, they are not as suitable for improving conversations and participation across distributed online communities.

Hence, there is a need for a portable reputation management system that can allow users to have unique reputation score which can be carried across various communities where he/she participates. There is a need of a system that enables better participation by allowing users in distributed online communities to rate each other. Such ratings may be used to calculate a unique reputation score across different communities for each user. There is also a need for a reputation management system that can give more prominence to contribution from a user having a higher reputation score. Further there is a need for a system which can filter and sort the contributions based on their quality. Also there is a need for reputation management system that provides greater incentives for each user to contribute better content and rate contribution from other users, thereby improving the quality of community discourse.

### BRIEF SUMMARY OF THE INVENTION

A method and a system for evaluating the quality of a contribution made by a user in a distributed online community framework are disclosed. The quality of contribution is assessed by creating a reputation profile of the user across multiple online communities. The reputation profile contains a reputation score, user identification information, user albums, user participation statistics and user contribution information. The reputation profile also shows the rank of the users based on their reputation score. Reputation score of a user indicates the credibility of the user. Such reputation score is calculated based on the feedback provided by other users for the contribution made by the user. The system also allows maintaining and publishing a unique reputation profile across the distributed online communities. Maintaining the reputation profiles incentivizes users to contribute better quality content. This improves the overall quality of the community discourse.

### BRIEF DESCRIPTION OF THE DRAWINGS

FIG. 1 is an overview of the environment in accordance with an embodiment of the invention.

FIG. 2 is a diagram discussing the elements of reputation profile manager according to an embodiment of the invention.

FIG. 3 is a flowchart representing a method to evaluate the quality of contribution of user accordance with an embodiment of the invention.

FIG. 4 is a flow chart discussing the updating of the reputation score in accordance with an embodiment of the invention.

FIG. 5 is a detailed flowchart representing a method to assign a reputation score in accordance with an embodiment of the invention.

FIG. 6 is a flowchart discussing an approach for validating the user of an online community in accordance with an embodiment of the invention.

FIG. 7 is a flowchart discussing an approach for validating the contribution of the user in accordance with an embodiment of the invention.

FIG. 8 is a detailed block diagram depicting the elements of the invention in accordance with an embodiment.

FIG. 9 is a diagram discussing the criterion for calculating reputation score of user in accordance with an embodiment of the invention.

FIG. 10 is an exemplary representation of reputation profile for a user according to an embodiment of the invention.

FIG. 11 is a flowchart representing a method to evaluate the quality of contribution of a user in a particular domain in accordance with an embodiment of the invention.

FIG. 12 is a flowchart representing a method to evaluate the quality of contribution made by a first user with reference to a second user in accordance with an embodiment of the invention.

### DETAILED DESCRIPTION

### DEFINITIONS

Online community: An online community is a group of people that primarily interact over a virtual medium, such as the Internet, rather than face to face. Example of an online community includes: social communities, discussion forums, blogs, wikis, social book-marking sites photo sharing community, video sharing community and the like. Online community can also be a network of people connected to fulfill a business need or commercial activity. A discussion forum in an e-commerce site is one example of such an online community. These online communities may also include online buyer/seller communities, business related communities, cooperative business relationships, professional associations and like.

Online Community Owner: An online community owner or administrator is an individual or an organization that manages the activities in the online community. Owners can, and have the authority to, configure the online community to suit the needs of the online community.

Reputation: Reputation is the opinion (or a social evaluation) of the community towards a person, group, or an organization. In an online community, which is a group of people interacting via internet, online reputations play an important role in determining the credibility of a particular user in the online community.

Plugin: Plugin is a computer program that interacts with a host application software (for example a web browser or an email client) to provide a certain, usually very specific, function on demand. Applications support plugins for many reasons. Some of the main reasons include: enabling third party service providers to create capabilities to extend an application, reducing the size of an application, and separating source code from the an application because of incompatible software license.

User: User is a person who participates in an online community and provides contribution to the activities going on in the online community.

Contribution: Contribution is any input provided by the user in an online community. Such input may be an article, comment, reply, rating, vote, testimonial, query, photo, video and the like.

Contribution score: Contribution score is an index that represents the quality of a contribution made by a user. It can be numerical value or its derivatives, grade, graphical representation and the like. It must be apparent to a person skilled in the art that any other mode can be used to represent the contribution score without deviating from the scope of the invention.

Feedback on a contribution: Feedback on a contribution is any comment, article, reply, rating, vote, testimonial, query and the like in response to a contribution made by a user. Users can provide feedback to each other.

Contribution information: Contribution information is the record of all information pertaining to a contribution of a user. Contribution information includes the contribution as well. Further, it includes any feedback on the contribution. It may also include the date and time of submission of the contribution, and/or date and time of feedback to the contribution. It must be apparent to a person skilled in the art that contribution information may not be limited to the items mentioned above, and can include any information that is related to the contribution.

Reputation score: Reputation score is an index that represents the reputation of a user across multiple online communities. It can be numerical value or its derivatives, grade, graphical representation and the like. It must be apparent to a person skilled in the art that any other mode can be used to represent the reputation score without deviating from the scope of the invention. Reputation score can be used to assess the quality of contribution of a user across multiple online communities.

Reputation profile: Reputation profile provides snapshot of a user's activity across various online communities. The snapshot can include user profile information, reputation score, contribution across online communities, feedback on such contributions, statistics on user's online behavior and the like. This snapshot helps the rest of the community assess the quality of the user's contribution.

Domain specific reputation score: Domain specific reputation score is an index that represents the quality of contribution made by a user in specific domains in an online community. Example of specific domains can include sports, politics, science, technology, love, astrology and the like. Domain specific reputation score can be numerical value, grade, graphical representation and the like. It must be apparent to a person skilled in the art that any other mode can be used to represent the domain specific reputation score without deviating from the scope of the invention.

Viewer specific reputation score: Viewer specific reputation score is an index that represents the quality of contribution made by a first user with reference to a second user on an online community. Viewer Specific reputation score can be numerical value, grade, graphical representation and the like. It must be apparent to person skilled in the art that any other mode can be used to represent the domain specific reputation score without deviating from the scope of the invention.

Relevance score: Relevance score is an index that represents the relevance of contributions to a set of user attributes and domains. Example of specific domains can include sports, politics, science, technology, love, astrology and the like Examples of user attributes can include name, nationality, birth sign, birth date, favorite domain, native language, favorite communities and the like. Relevance score can be numerical value, grade, graphical representation and the like. It must be apparent to person skilled in the art that any other mode can be used to represent the domain specific reputation score without deviating from the scope of the invention.

### DESCRIPTION OF THE INVENTION

A method and a system for evaluating the quality of a contribution made by a user in an online community are disclosed. The quality of contribution is assessed by determining a reputation score for the user. This score is a function of contributions made by the user across various online communities. The reputation score is also a function of the assessment of the user's contribution by other users of the online communities. The method provides for users in distributed communities to rate each other. The content provided by a user with a higher reputation score is given more prominence. The invention further discloses a method and system for maintaining reputation profiles of users of online communities. The reputation profile provides a snapshot of the user's contribution across various online communities. This snapshot helps other users to assess the quality of the user's contribution. Maintaining the reputation profiles incentivizes users to contribute better quality content. This improves the overall quality of the community discourse. It must be apparent to a person skilled in the art that although the invention has been discussed in conjunction with online communities, the invention is applicable to any form of online activity that has user generated content without deviating from the scope of the invention.

Although discussed with reference to certain illustrated embodiments, upon review of this specification, those of ordinary skill in the art will recognize that the present scheme may find application in a variety of systems. Therefore, in the following description the illustrated embodiments should be regarded as exemplary only and should not be deemed limiting in scope.

The system may be embodied in a variety of different types of hardware and software using combinations of both server-side and client-side hardware and software components, as is readily understood by those of skill in the art.

One embodiment of the present invention may be implemented as computer software incorporated as part of an online community system. The online community system operates with a computer system using a Windows, Macintosh, UNIX, Linux or other operating system equipped with a Web browser application, or other Web-enabled device capable of connecting to the Internet or other network system. It should be noted that the term “Internet” is intended to encompass similar systems and nomenclature (i.e., World Wide Web or “www”) comprising the capability to communicate and access information through a network, telephone connections, ISDN connections, DSL connections, cable modem, fiber optic network, etc. The present invention should not be limited in its communication nomenclature; the present invention is applicable to any system that is accessible by means of a Web browser, or other means of communicatively coupling one device or server to another.

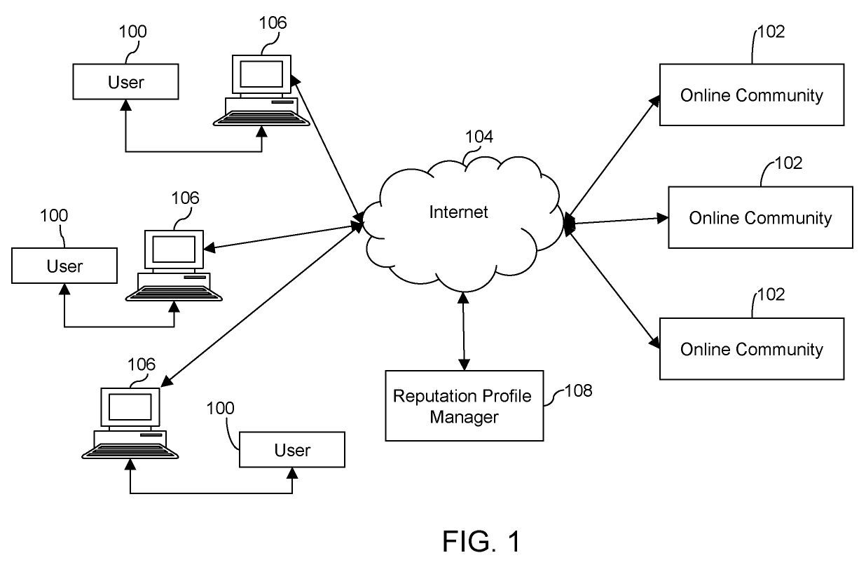

FIG. 1 is an overview of the environment in accordance with an embodiment of the invention. As shown in the figure, one or more users 100 are connected to one or more online communities 102 over Internet 104 through client devices 106. It must be apparent to a person skilled in the art that although the Internet has been mentioned as the platform for communication, the invention is equally applicable on other forms of network such as LAN, WAN, mobile network, and the like without deviating from the scope of the invention. Further the client devices can be personal computers, laptops, PDAs, or any other form of device that can be used to communicate with the network.

Users 100 participate in various activities across multiple online communities 102 and make contributions. A Reputation Profile Manager 108 is connected to multiple online communities 102 and users 100 through internet 104. Reputation Profile Manager 108 maintains the reputation profiles of all users 100 that participate in different online communities 102. Further, reputation profile manager 108 makes the reputation profile of the user available across all online communities 102 where the user participates. This reputation profile may be viewed by all users 100 that participate in online communities 102.

According to an embodiment of the invention, the reputation profile of the user is unique across all online communities 102. The reputation profile may comprise user identification information, a reputation score, and a record of previous contributions made to all online communities 102 where the user has participated in. According to an embodiment of the invention, reputation profile of the user also has links to all online communities 102 where the user has participated. Therefore, any user of a particular online community 102 can view links to all online communities where a particular user has participated. This view of the reputation profile of users helps participants across online communities to assess each other's quality of contribution. This helps in increasing the participation across all online communities 102 linked to reputation profile manager 108. According to an embodiment of the present invention, the reputation profile also contains statistics on the user's activities across multiple online communities for example, the statistic on number of times the user visited a particular online community. It will be apparent to a person skilled in the art that the reputation profile may include other information about a user without deviating from the scope of the invention.

As used herein, the term “online community” 102 includes, without exception, all discussion forums, blogs, wikis, social book-marking sites, social media platforms, online buyer seller communities, photo and video sharing sites, business related communities and the like. Online community may be hosted on a computer server of the type that is well known to those of skill in the art. Such a server may include a processor, transient memory (e.g., RAM), persistent memory (e.g., hard drive), input device and circuitry to provide communication paths between the components.

“Internet” generally refers to any collection of distinct networks working together to appear as a single network to a user. The term refers to the so-called world wide “network of networks” connecting networks to each other using the Internet protocol (IP) and other similar protocols. It will be understood that although the description may refer to terms commonly used in describing particular public networks such as the Internet, the description and concepts equally apply to other public and private computer networks. For example and without limitation thereto, the system of the present invention can find application in public as well as private networks.

Client devices 106 may include virtually any computing device capable of receiving and sending a message over a network, such as Internet 104, to and from another computing device. Such devices may include devices that typically connect using a wired communications medium such as personal computers, multiprocessor systems, microprocessor-based or programmable consumer electronics, network PCs, and the like. The set of such devices may also include devices that typically connect using a wireless communications medium such as cell phones, smart phones, pagers, walkie talkies, radio frequency (RF) devices, infrared (IR) devices, integrated devices combining one or more of the preceding devices, or virtually any mobile device, and the like. Similarly, client devices 106 may be any device that is capable of connecting using a wired or wireless communication medium such as a PDA, POCKET PC, wearable computer, and any other device that is equipped to communicate over a wired and/or wireless communication medium.

Each client device 106 may include a browser application that is configured to receive and to send web pages, and the like. The browser application may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, JavaScript, and the like.

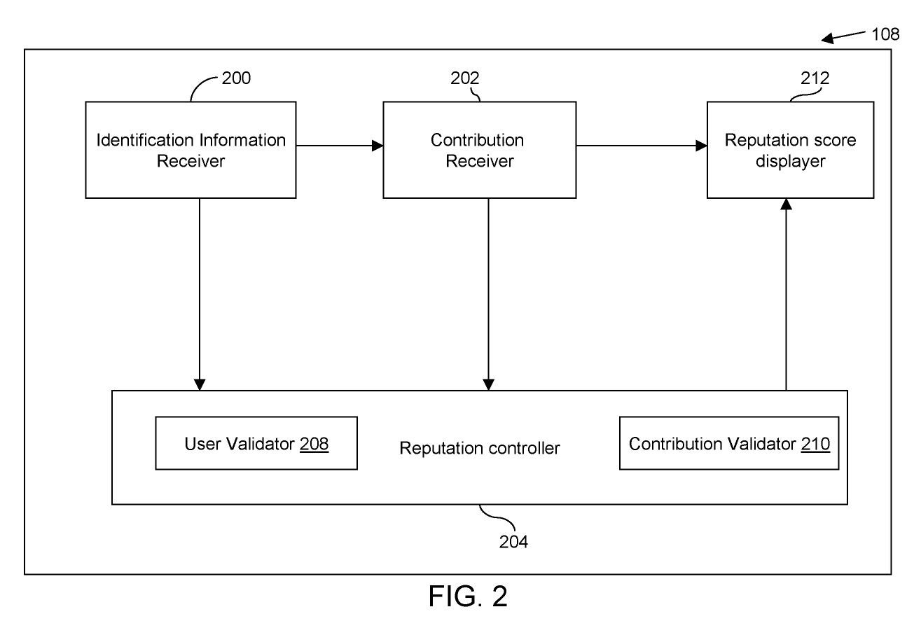

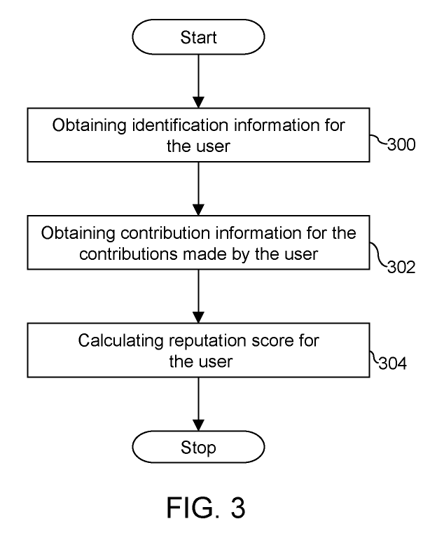

FIG. 2 is a block diagram depicting the elements of Reputation Profile manager 108 in accordance with an embodiment of the present invention. The invention is related to a method and a system for assessing the quality of contributions made by users 100 of online communities 102. The method entails making and maintaining a reputation profile of the user on reputation profile manager 108. The reputation profile indicates the quality of contribution made by the user to the online community. As shown in the figure, Reputation Profile Manager 108 has an Identification Information receiver 200. Identification information receiver 200 receives user identification information. Identification information has been explained in detail in conjunction with FIG. 3. Contributions made to multiple online communities 102 are received by Contribution receiver 202.

Contributions made by user 100 to multiple online communities 102 may be in the form of comment, reply, query, photo, video or any other input given by the user to an online community 102. A user can give a rating to contributions made by other users. This rating may be quantitative or qualitative. The rating can be given to a user, a user's contribution, the online community as a whole on which the contribution is made and the like. Contributions can also be in the form of a user vote on an ongoing discussion in the online community. For example, if the online community is a blog, the contribution may be a comment on the blog. Similarly, if the online community is a Wiki, the contribution may be in the form of an article. In other embodiments, contribution by the user may be in the form of feedback, reply, query or any other input given by the user to an online community. Users 100 of the Online Community 102 give feedback on contributions made by each other. For example, if user A inputs a new post on a blog, other users can view the blog and provide their comment, rating etc on the blog. This comment, rating etc provided on user A's contribution is termed as feedback.

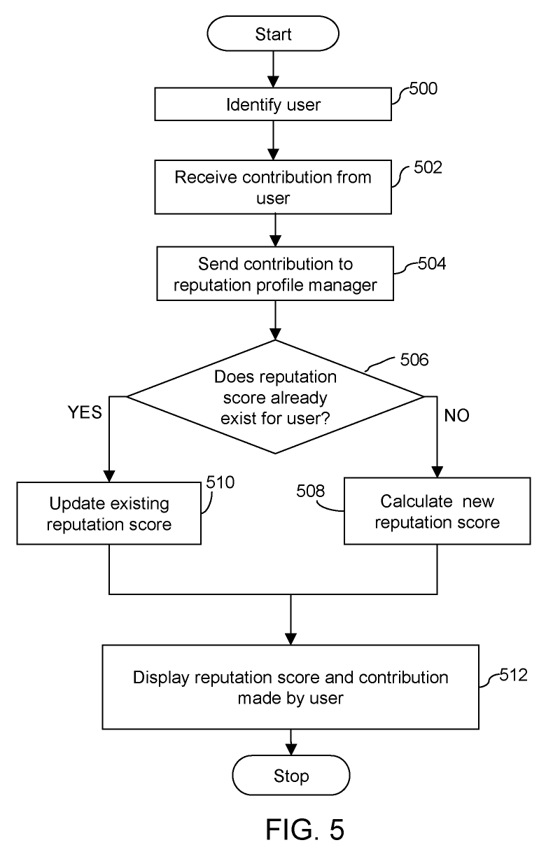

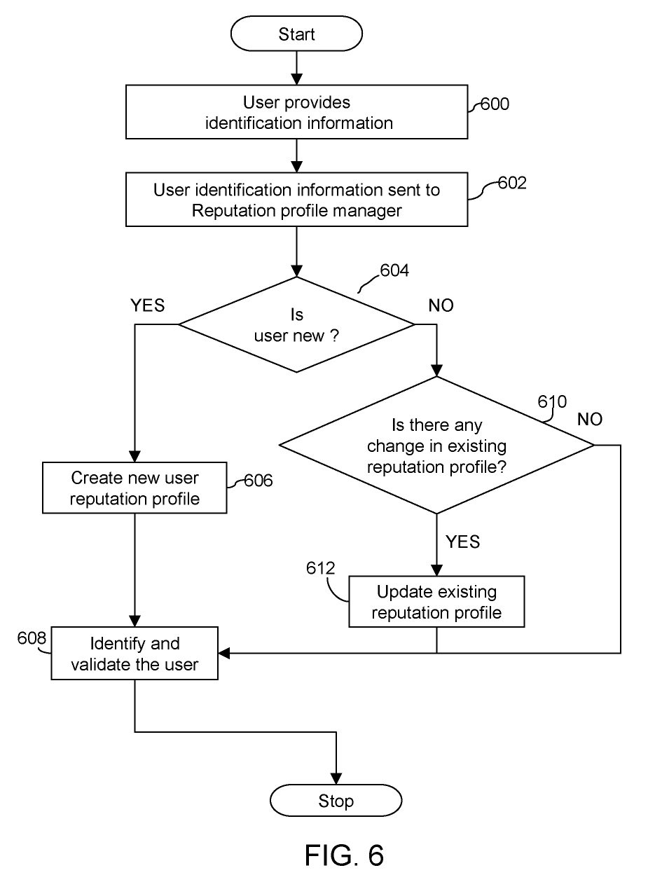

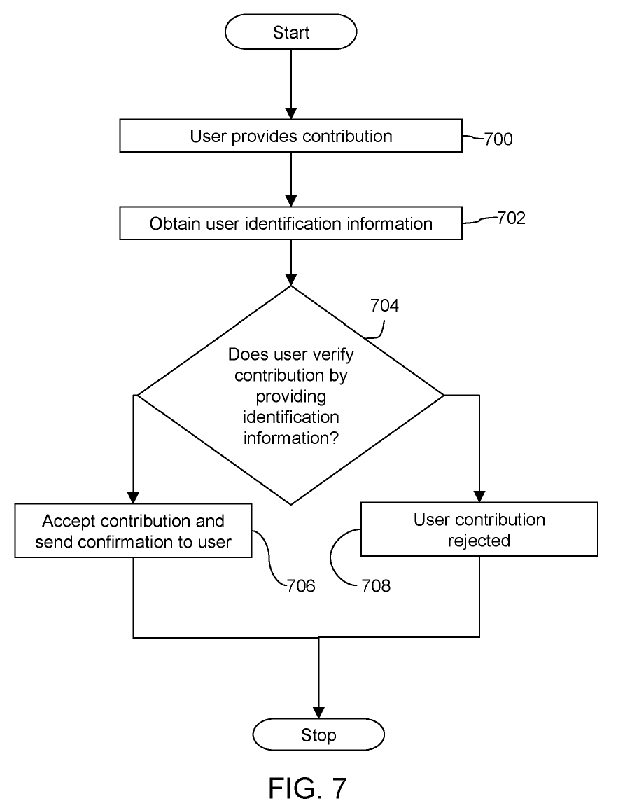

Feedback is also received by Contribution receiver 202. The User identification information received by the identification information receiver 200, contributions and the feedback received by Contribution receiver are then sent to Reputation Controller 204. Reputation controller 204 validates the user through user validator 208. User validator 208 analyzes the identification information to validate the user. This step has been explained in detail in conjunction with FIG. 6. Reputation controller also validates the user contribution through contribution validator 210. This step has been explained in detail in conjunction with FIG. 7. Reputation controller 204 further creates and updates the reputation profile of users. According to an embodiment of the invention, if a user is new and does not have a reputation profile, a new reputation profile is created. The Reputation controller 204 maintains a reputation profile for the new user based on the contributions of the user and the feedback provided by other users on the contribution. Reputation profile for a user includes reputation score for the user and record of all the contributions made by the user. Reputation controller 204 also calculates the reputation score for a user based on the contribution made by the user and feedback given by other users on the contribution. This step of calculating reputation scores of users has been explained in detail in conjunction with FIG. 5.

The reputation profile for all the users of an online community is displayed on the online community through Reputation Profile Displayer 212. Reputation Profile Displayer 204 receives reputation profile information from Reputation Controller 204 and sends it to the online communities. According to an embodiment of the invention, the reputation profile of users is sent to the online communities periodically. According to another embodiment of the invention, the reputation profiles of users are sent to the online community on demand, as and when online community sends request for reputation profile of a user.

According to an embodiment of the invention, a user can contribute across multiple online communities and reputation controller 204 would maintain a unique reputation profile for the user across all the online communities in which the user contributes.

FIG. 3 is a flowchart representing a method to evaluate the quality of contribution of a user in accordance with an embodiment of the invention. At step 300, the user is identified on online community 102. The identification is done on the basis of identification information of the user. Identification information is information pertaining to the user that can uniquely identify the user. The identification information may be the login name, email id, picture, birth date or any such user specific information. According to an embodiment of the invention, the identification information is provided by the user. According to another embodiment of the invention, the identification information can be obtained directly by identifying client device 106. For example, user identification information can be obtained through the Internet protocol (IP) address of client device 106. It will be apparent to a person skilled in the art that the present invention is in no way limited to the modes of obtaining identification information as described above. The step of identifying the user has been explained in detail in conjunction with FIG. 6.

At step 302, contribution information for the contributions made by the user across multiple online communities 102 is obtained. Contribution information has all the information available for a contribution made by the user along with the contribution. The contribution information includes the feedback for the contribution provided by other users. The contribution information also includes the date and time of submission of the contribution and the time of submission of the feedback for the contribution. According to an embodiment of the invention, contribution information contains the information about the category to which the contribution belongs. For example, contribution information can have information on whether the contribution is an article, a comment on an article, rating for a contribution, voting and the like.

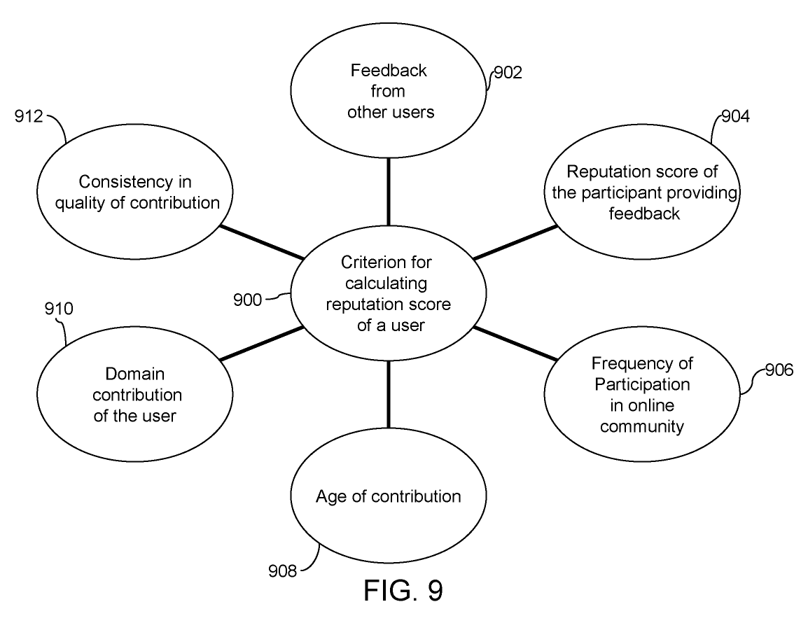

At step 304, the reputation score for the user is calculated based on the contribution information of the contributions made by the user across multiple online communities. The calculation of reputation scores is done on the basis of various factors like feedback received for the contributions of the user, frequency of participation, reputation score of the user providing feedback, consistency in providing feedback to other users and the like. These factors and the details on computing the reputation score are discussed in conjunction with FIG. 9.

The reputation score is used as an indicator to evaluate the quality of contribution made by user 100. A user having high reputation score would be expected to give contributions of high quality.

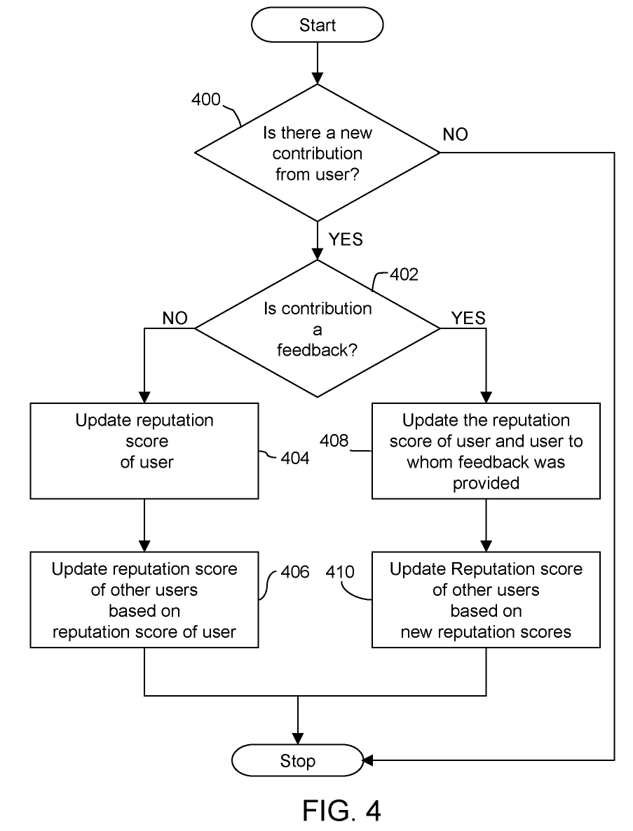

FIG. 4 is a flowchart representing a method to update the reputation score of users across multiple online communities in accordance with an embodiment of the invention. At step 402, any new contribution made to an online community is obtained. If there is no new contribution, the updating process is terminated without any further action. In case there is a new contribution, the user making the contribution is identified at step 404. For purposes of clarity, the user that made the contribution can be referred to as the first user. Details on identifying the first user have been discussed in detail with FIG. 6. At step 406, specifics of the nature of contribution are determined. In accordance with an embodiment of the invention, this step involves determining whether the contribution is a feedback or not. According to an embodiment of the invention, nature of the contribution can be determined based on the user input. For example, user may click on feedback button for submitting feedback. For purposes of clarity, the user providing the feedback can be referred to as a second user.

In case the contribution is not a feedback, at step 408, the reputation score of the first user is updated based on the new contribution made by the first user. The updating of reputation score also takes into account the previous reputation score of the first user. In an embodiment of the invention, the frequency of posts on the blog can be the basis of updating the reputation score. For example, in case of a blog, when a new post is made on the blog post, the reputation score of the person who added the post is updated. Details on the computation of the reputation score are described in detail in conjunction with FIG.9. It will be apparent to a person skilled in the art, that the mode and basis of updating a reputation score described above is merely exemplary in nature, and any other basis of updating the reputation score can be applied with out deviating from the scope of the invention.

At step 410, reputation scores of all other users across the plurality of online communities are updated on the basis of the updated reputation score of the first user. This has been explained in detail in conjunction with FIG. 9. In an embodiment of the invention, if the second user, who has a higher reputation score, provides positive feedback to the first user, the reputation score of the first user will be impacted positively. However, if the reputation score of the second user is affected negatively, it will have a corresponding negative effect on the reputation score of the first user.

If the contribution at step 406 is a feedback, then at step 408, the reputation scores of the first user and the second user are updated. At step 410, the reputation scores of all other users are updated on the basis of the updated reputation scores of the first user and the second user.

According to an embodiment of the invention, reputation scores are updated immediately whenever a user submits a contribution. According to another embodiment of the invention, the reputation scores are updated periodically. In yet another embodiment of the invention, the reputation scores are updated upon an external request. For example, in case of a blog, a person browsing the blog can request to see the reputation score of a user who has posted a comment to the blog. To serve the request, the reputations score is updated at that instance.

FIG. 5 is a detailed flowchart representing a method to assign a reputation score in accordance with an embodiment of the invention. At step 500, the user is identified on online community 102. This step has been explained in detail in conjunction with FIG. 6.

At step 502, contribution is received from the user on online community 102. For example, when the online community is a blog, the contribution may be a comment provided by the user on the blog. In other embodiments, contribution by the user may be in the form of feedback, reply, query or any other input given by the user to an online community.

At step 504, the contribution provided by the user is sent to reputation profile manager 108. According to an embodiment of the invention, contribution provided by the user can be sent to reputation profile manager 108 in a compressed meta-data form. At step 406, reputation profile manager 108 checks whether a reputation score already exists for the user. The reputation score for the user indicates the quality of contribution or credibility of the user. For example, when the online community is a blog, the user who writes a very pertinent comment to a discussion gets a high reputation score for the comment whereas another user who writes irrelevant comments gets a low reputation score. When the user registers at reputation profile manager 108, he/she may not have a reputation score. Registration has been explained in detail in conjunction with FIG. 6. Reputation score is provided to the user for every contribution he/she makes to online community 108. The reputation score may increase for a good contribution i.e. rated good by other users 100 but may decrease for a bad contribution i.e. rated bad by other users 100.

If a reputation score does not exist at step 506, then step 508 is executed or else step 510 is executed. At step 508, a reputation score is calculated for the user based on the contribution provided by the user. At step 510, the existing reputation score is updated based on the contribution made by the user to online community 102. At step 512 reputation score and contribution made by the user is displayed on online community 102. The display might be done in form of AJAX (Asynchronous Javascript and XML) or other such javascript based pop-up on online community 102 or it can be provided on site hosted by other online community 102.

According to an embodiment, contribution made by the user having a higher reputation score is given prominence on online community 102. In one embodiment of the invention, the user with the highest reputation score may be approached to promote various products and services of online community 102 and rewarded in return.

When the user participates in multiple online communities the reputation profile of the user remains unique across all the online communities. In this case, the reputation profile of the user on one community displays links to other online communities 102 visited by the user. So any other user who views such reputation profile can view all these links. This helps in increasing the participation in the multiple online communities where the user participates

According to an embodiment of the invention, a rank is computed for each user based on the computed reputation score. The rank can be assigned with respect to the users of the same online community or with respect to the users of multiple different online communities.

According to another embodiment of the invention, users can be selected for promotions of various products and services. This selection can be made based on the reputation score. In an embodiment of the invention, the rank of the user is used for selecting the user for promotions. For example, user with the top 10 ranks in the health online community might be contacted for promotion of a new healthcare product. According to another embodiment, contributions made by users are shown prominently based on their ranks. For example, in a blog, a comment posted by the user having the highest rank is highlighted. This motivates users to contribute better content in the online community.

In accordance with an embodiment of the invention, the reputation score can be used to create a ‘hall of fame’ of users. For example, in a video sharing community users who consistently maintain a rank in top 100 for 3 continuous years are identified and are honored with a badge of Hall of Fame to give recognition for their good participation.

According to another embodiment contributions made by users on online community 102 are given a contribution score based on the feedback provided by other users on the contributions. According to another embodiment contributions are filtered and sorted based on the contribution scores. For example all the contributions having contribution score below certain threshold contribution score would not be shown on online community 102. According to another embodiment all the contributions made are ranked based on their contribution score and a user is shown the contributions in decreasing order of their ranks.

FIG. 6 is a flowchart representing a method to validate the user of an online community in accordance with an embodiment of the invention. In order to build a strong incentive based model for community participation, it is important to ensure proper identification and validation of the user. In a community where the user is not securely identified and validated, impersonation becomes very easy. Hence proper validation of the user as shown here is very important. At step 600, the user provides user identification information on an online community. User identification information may be the login name, email id, picture, birth date or any such user specific information. According to an embodiment, registration for the user is done based on user identification information. According to an embodiment of the invention, a user can register his/her reputation profile by registering in an online community. The profile information is then sent to the reputation profile manager 108 which creates a reputation profile and manages it. According to another embodiment of the invention, reputation profile manager 108 provides a web based interface to users and users can directly register on reputation profile manager 108.

At step 602, user identification information is sent to reputation profile manager 108. At step 604, a determination is made as to whether the user is new or not. If the user is new (i.e., the user is not already registered either on online community or reputation profile manager), then step 606 is executed or else step 610 is executed. At step 606, user reputation profile is created. According to an embodiment of the invention, the user is required to perform email verification or word verification before the reputation profile is created. Email verification helps in preventing impersonation. The user is requested for an email id. When the request is made for creation of a new profile, the user is sent an email to the email id. The user is requested to confirm this request by replying to the email. Alternatively, an access password for the profile is sent to the user on the provided email id. This ensures that no user can impersonate some other user by using his/her email id.

Word verification helps in preventing automatic machine generated profiles by miscreants. Whenever a request for creating new profile is made, user is requested to enter some word as written on screen. On providing the word verification, user profile is created. User reputation profile has information like user identification information, past contribution to online community and reputation score. According to an embodiment of the invention, the user might be asked for additional identification information like address, phone number, nationality and the like while creating a reputation profile.

At step 608, the user is validated, i.e., the user is allowed to contribute and participate in activities of the online community.

If the user is not new (i.e., the user is already registered either on online community or reputation profile manager), then at step 610, the reputation profile of the user is checked for any modification. In case of any modification, step 612 is executed or else step 606 is executed. At step 612, the user is allowed to update the existing reputation profile. The user can update the reputation profile by modifying the old identification information or by adding other identification information. After this, step 608 is executed and the user is validated.

Due to privacy and security concerns, online community sites or services may not want to display personal information like email address, phone number and the like which uniquely identifies a user. To address this issue, the online community allows users, to choose a display name that is then displayed to the other users of the community. This display name can be used to identify the user. This leads to problems of identity and impersonation, where other users could use the same display name with different identification information. Users are unlikely to trust the reputation scores if the display names of the users are changing. These problems reduce the effectiveness of a reputation based model. According to an embodiment of the invention user can choose a unique display name based on his/her identification information such as email id. This would prevent any other user from using the same display name. According to another embodiment of the invention, the user is required to verify his/her contribution over an email. Alternatively, a password can be requested prior to accepting a new contribution from a user. This has been explained in detail in conjunction with FIG. 7. According to an embodiment of the invention, user identification information is directly given on reputation profile manager 108. This information is then sent to the online community over Internet 104 as described in FIG. 1.

FIG. 7 is a flowchart discussing an approach for validating the contribution of the user in accordance with an embodiment of the invention. At step 700, user 100 provides contribution to online community 102. At step 702 user identification information is obtained. The user identification information may be the login name, email id, picture, birth date or any such user specific information. According to an embodiment, user 100 is requested for identification information whenever he makes a new contribution. For example, whenever user 100 makes a contribution, an email may be sent to user 100 or a message may be sent to his/her mobile phone asking to verify the contribution made. According to another embodiment, user identification might be obtained from the IP (Internet Protocol) address of client device 106.

At step 704, a determination is made whether user 100 has verified the contribution or not by providing his/her identification information. If user 100 has verified the contribution, step 706 is executed or else step 708 is executed. At step 706, contribution is accepted and confirmation is sent to user 100. Confirmation to user 100 can be sent on email, phone or a confirmation message can just be displayed in user reputation profile. According to an embodiment of the invention, confirmation can be sent to an inbox provided to the user on the community where contribution is made. Password to such an inbox would be known only to the user. If the user doesn't verify the contribution, then step 708 is executed wherein the user contribution is rejected. According to an embodiment, whenever a user posts a contribution, the display name and email address provided by user 100 is recorded. If anytime in future, user 100 posts another contribution using the same display name, user 100 is required to enter the same email address that was provided the first time for that display name. This helps in preventing impersonation by other users.

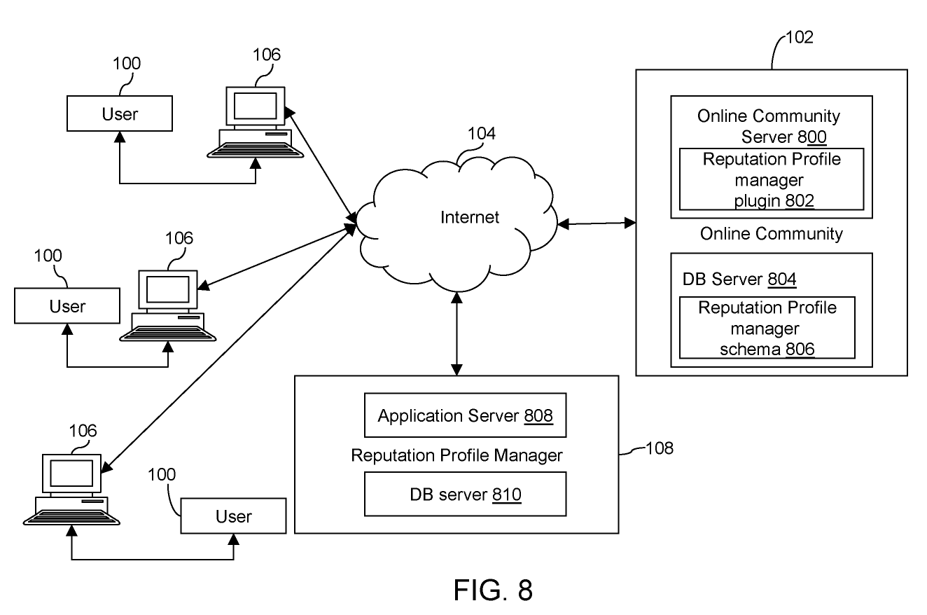

FIG. 8 is a detailed block diagram depicting the elements of the invention in accordance with an embodiment. Online community 102 is hosted on an online community server 800. Online community server 800 has a plugin 802 that integrates online community with reputation profile manager 108. For example, plugin 802 enables reputation profile manager 108 to manage the display of reputation profiles of users on online community 102. Plugin 802 handles all the communication with reputation profile manager 108 via web based services.

According to an embodiment of the invention, a downloadable plugin 802 provided by reputation profile manager 108 is installed, implemented and deployed in online community server 800 by online community owners.

According to an embodiment of the invention, when plugin 802 is installed and enabled for the first time, it contacts reputation profile manager 108 and gets a site key. This site key is stored internally. Site key helps to validate the normal functioning of the communication channels with reputation profile manager 108. Also, the site key is used to inform reputation profile manager 108 of the configuration options provided by the community owner. Further, the site key is also useful for security validations.

The online community owners need to enable and activate their online community for interaction with reputation profile manager 108. According to an embodiment of the invention, online community owners need to register on reputation profile manager 108. The online community owners may register on reputation profile manager 108 by providing information such as email id, login name and the like.

There may be two kinds of registration, one for personal and the other for commercial communities. Registration may be charged or free depending on the type of community for which the registration is done. According to an embodiment of the invention, registration for a personal online community may be free. However, reputation profile manager 108 may impose limits on the number of users in such online communities and may stop providing services if the limits are exceeded. Only one personal online community may be registered each time.

Once successfully registered, an online community key is generated and emailed to the online community owner. The online community owner needs to enter the online community key into the User Interface provided by the plugin for the online community owner. This activates the online community for reputation profile manager 108. For commercial online communities, the owner may register multiple online communities and the fee will be computed based on the number of online communities. There may still be internal usage limits on each online community; however, the limit can be much higher for commercial online communities. According to an embodiment of the invention, there is an approval step involved in the registration to verify the payment and other information.

Once the registration has been approved, online community keys (one per online community) may be generated and emailed to the online community owner. In the case of commercial communities, the hosting site may be buying the online community keys on behalf of their online community owners (so as to encourage more online community owners to join their site). For example, consider the case of a blogging site such as www.blogspot.com (‘blogspot’): blogspot may buy the community keys on behalf of all the blog owners having a blog hosted on blogspot. In such a case, they can assign the key to each owner and ask him/her to enter it into their online community setup UI. When the online community key is entered, the plugin checks that the online community key has not been already assigned to any other online community in the site. It then sends the online community key along with the site-key to reputation profile manager 108 for activation. Reputation profile manager 108 then checks whether the key is valid or not. If the key is valid, then the reputations profile manager 108 assigns the online community key to the site and activates the online community. During the activation of the online community, some of the information about the online community can be collected. Example of such information can include: URL of the online community, brief text description from the online community, subject, and the like.

According to an embodiment of the invention, reputation profile manager 108 provides a user interface for online community 102 owners to configure the functionalities of the service provided by reputation profile manager 108. For example, some online community 102 owners may like to display contributions from only those users that have the highest reputation scores while other owners may like to display contributions of users in decreasing order of reputation scores of users, i.e. a contribution made by a user with higher reputation score is shown first. All such services provided by reputation profile manager 108 may be configured through the user interface. Online community 102 has a Database (DB) server 804 that maintains a local data store of online community 102. The local data store contains information like contributions made by all users of online community 102. DB server 804 may also contain schema 806 to maintain meta data (compressed data) used for identifying reputation profiles maintained by reputation profile manager 108.

Reputation profile manager 108 has an application server 808 that interacts with plugin 802 through a web service. Application server 808 allows reputation profile manager 108 to interact with online community 102 through plugin 802. Reputation profile manager 108 maintains the reputation profiles of all users of online communities 102. The data is maintained in a DB server 810 in reputation profile manager 108 and is updated by reputation profile manager 108 at runtime. Hence, as soon as a fresh contribution is made by the user, a new reputation score is calculated by reputation profile manager 108 and this information is updated on DB server 810. The updated reputation profiles are made available to online community server 800 through application server 808.

FIG. 9 is a diagram showing the criterion for calculating reputation score of user 900 in accordance with an embodiment of the invention. The method takes into account various factors while calculating reputation score of the user. Feedback 902 given by other users in the community is one of the important factors. Feedback is a rating provided by users to each other's contributions. According to an embodiment of the invention, feedback given by online community 102 owners is also taken into account. Such ratings would be an important factor in deciding the user reputation score because of higher trust position typically assigned to such owners. Another important factor is the reputation score of the user providing the feedback 904. Feedback provided by a user having higher reputation score is given higher weightage. For example, consider the following scenario in a blog community: user Sam, with reputation score α, provides a positive rating of 2 to a comment by Shreya, and user Bob, with reputation score β(α>β) provides a negative rating of 2. In such a situation, Shreya's reputation score will have a net positive effect.

Frequency of participation 906 by the user in online community 102 is also taken into account while assigning reputation score to the user. Hence the user who participates more in online community 102 will have a higher reputation score as compared to another user who participates less. This encourages higher participation by users of online community 102. Age of contributions 908 made by the user in online community 102 is also very important for assessing reputation score of the user. Therefore, contributions made by the user recently will have a higher weightage for calculating the reputation score as compared to contributions made earlier. According to an embodiment of the invention, domain contribution 910 of the user is also taken into account while calculating the reputation score. Therefore, a user might have a separate reputation score in separate domains. According to another embodiment of the invention, consistency in quality of contribution 912 is also taken into account for calculating the reputation score of the user. Therefore, a user who consistently gets a good rating from other users will get a boost to his reputation score. On the other hand, the user getting wider variation in ratings from other users will have a lower reputation score.

It will be apparent to the person skilled in the art that the calculation of the reputation score is not limited to the factors as described above. It can include other factors without deviating from the scope of the invention.

The following section provides an example of the manner in which the reputation scores are calculated in one embodiment. It will be apparent to one skilled in the art that the method of calculation of reputation scores may not be limited to the one provided in the example below. For example, in the case of online blog communities, reputation score (RS) is calculated based on the contribution score(CS) of the comment made by the user, recency of the comments made, total number of comments made by the user and the total rating provided by the user for comments made by other users. CS of a comment is based on the ratings(R) provided by other users on the comment, RS of the rater and RS of the commenter. In this case RS and CS are calculated in such a way that changing the scores around the average score is easy but it becomes progressively harder as scores approach either extreme. Rating (R) is provided on a scale of 0-10.

CS of a comment and RS of a user are calculated on a scale from 0-10. In this case the default CS and the RS is 5 out of 10. The process of calculating CS for a comment is described below.

Initial CS=RS_{Commenter}* 10(10 is the highest CS)

This ensures that a comment made by a higher reputation person gets a higher CS compared to a comment made by a low reputation person.

Aggregate CS=RS_{Commenter}*10+RS_{Rater-n}*R_{Rater-n}

RS_{Rater-2}*R_{Rater-2}+ . . . RS_{Rater-n}*R_{Rater-n}

Here, there are n raters for the comment made by the commenter. This ensures that a comment that has received a higher number of positive ratings is going to be ranked higher compared to a comment with fewer ratings.

In this case CS and RS are scaled around the average to make it easy to move the score of the comment from the average, scaling of CS and RS is done around the default score of 5.

Scaled CS=(RS_{Commenter}−5)*10+RS_{Rater-1}*R_{Rater-1}+RS_{Rater-2}*R_{Rater-2}+.

RS_{Rater-n}*R_{Rater-n}−5*(RS_{Rater-1}+RS_{Rater-2} . . . RS_{Rater-n})

This will result in the default score for a new commenter (default RS score=5) to have a score of 0.

Scaled CS=(5−5)*10=0

A person with the default RS and with a comment that has been rated 10, by a user with RS 7. The scaled comment score will be calculated as follows:

Scaled CS=(5−5)*10+7*10−5*7=35

User with RS of 6 and with a comment that has been rated 0, by a user with RS of 7. The scaled CS will be calculated as follows:

Scaled CS=(6−5)*10+7*0−5*7=−25

Now scores are scaled such that the score move away from the default scores quickly but towards extremes, it gets harder to move the score. This has been accomplished by using a log function as described below.

Rescaled CS=log₁₀(Scaled CS), if (Scaled CS)>=1

0, if −1<(Scaled CS)<1

−1* log₁₀(mod (Scaled CS)), if (Scaled CS)<=−1

For the negative scores, first the modulus of the value is taken and then after taking log, value obtained is multiplied by −1.

Now CS is rescaled between 0-10. This can be accomplished by just adding 5 to the score.

CS=Rescaled CS+5

Initially when a user registers a default RS is assigned to the user. For calculating the RS of a user several factors need to be taken into account. In this case 3 components have been used for calculating the RS.

One of the main factors which influence each component is the time or age factor of the comment. For the computation of RS, Age is defined as the number of days passed since the date of submission of comment.

In order to convert the age to a weight that can applied to the component being measured, a log7 scale is used. The use of base 7 gives a nice fit to the calendar year of 365 days, dividing it into three key weight segments: those about a week (71=7 days), those about 1.5-2 months (72=49 days), those towards later half of year (73=343 days). Since a higher weightage is to be given to recent events, the scale is inverted by using (log7 365−log7 Age) as the multiplying factor. Owing to the low weight of events older than a year, and for data maintenance reason, only comments submitted in the past one year are considered.

Component 1—The first component computed is the time weighted average of the CSs of comments of a user. The CS, as described earlier, takes into account the ratings, rater's RS and commenter RS. For this component, only those comments are taken into account that have at least one rating. Also, as described above, only comments made within the past one year are considered. The computation is as follows:

CS_{Avg}=[CS₁*(log_{7 365}−log7 Age₁)+

CS₂*(log₇ 365−log₇ Age₂)+ . . . +

CSₙ*(log₇ 365−log₇ Ageₙ)]/

[(log₇ 365−log₇ Age₁)+

(log₇ 365−log₇ Age₂)+ . . . +

(log₇ 365−log₇ Ageₙ)]

Here CS₁, CS₂, . . . , CSₙ are the CS of the n comments submitted by the user within last one year. Also Age₁, Age₂, . . . , Ageₙ are the ages of the respective comments.

Component 2—The second component is the credit for number of comments made by the user. When counting the comments, the aging factor is used to give higher weightage to recent comments. This total is then scaled using a log scale, so as to gradually reduce the credit per comment as the number of comments increases. This is to discourage just blind entry of comments, without concern about their quality. To convert this to a percentage credit, log₁₀ (1000)=3 is used, assuming that 1000 comments earns the user full credit.

Comment Credit=log₁₀[(log₇ 365−log₇ Age₁)/log₇ 365+

(log₇ 365−log₇ Age₂)/log₇ 365+ . . . +

(log₇ 365−log₇ Ageₙ)/log₇ 365]/3

Component 3—The third component is the credit for number of ratings made by the user. Again, when counting the ratings, the aging factor is used to give higher weightage to recent ratings. Similar to the component 2, this total is then scaled using a log scale, so as to gradually reduce the “credit per rating” as the number of ratings increases. This is to discourage blind ratings, without actually reading the comment. Finally, to convert this to a percentage credit, log₁₀(10000)=4 is used, assuming that 10000 ratings earns the user full credit.

Rating Credit=log₁₀[(log₇ 365−log₇ Age₁)/log₇ 365+

(log₇ 365−log₇ Age₂)/log₇ 365+ . . . +

(log₇ 365−log₇ Ageₙ)/log₇ 365]/4

RS is now computed for the user by adding the 3 components as follows:

RS=A*CS_{Avg}+B*Comment Credit+C*Rating Credit

Here A, B and C are weighing factors having value less than 1. Their value might vary depending on the need of giving higher weightage to certain factors.

RS and CS are updated when a new comment is made or a new rating is provided on the comment made. According to an embodiment of the invention, change in RS of a first user affects the RS of a second user. For example, when a user A having RS η₁ provides a rating for a comment made by user B having RS θ₁, then RS of user B would change to θ₂ based on the RS η₁ of user A. Similarly if user B had provided a rating earlier for comment made by user A, then change in RS of user B from θ₁ to θ₂ would change the RS of user A from η₁ to η₂. This process would continue iteratively in a closed loop. To handle this problem, a damping factor (DF) is computed after every iteration as DF₁, DF₂, . . . , DFᵢ. For i^{th} iteration damping factor for user A would be computed as follows:

DFi=log₁₀(mod(log₁₀(ηᵢ₊₁)−log₁₀(ηᵢ)))

A predefined limit (or the threshold limit) λ is set for the damping factor. If the damping factor DFₙ after nth iteration falls below the threshold limit λ, the process is stopped and user A is assigned a final RS of ηₙ₊₁. Similar process would be followed for calculating a final RS for User B.

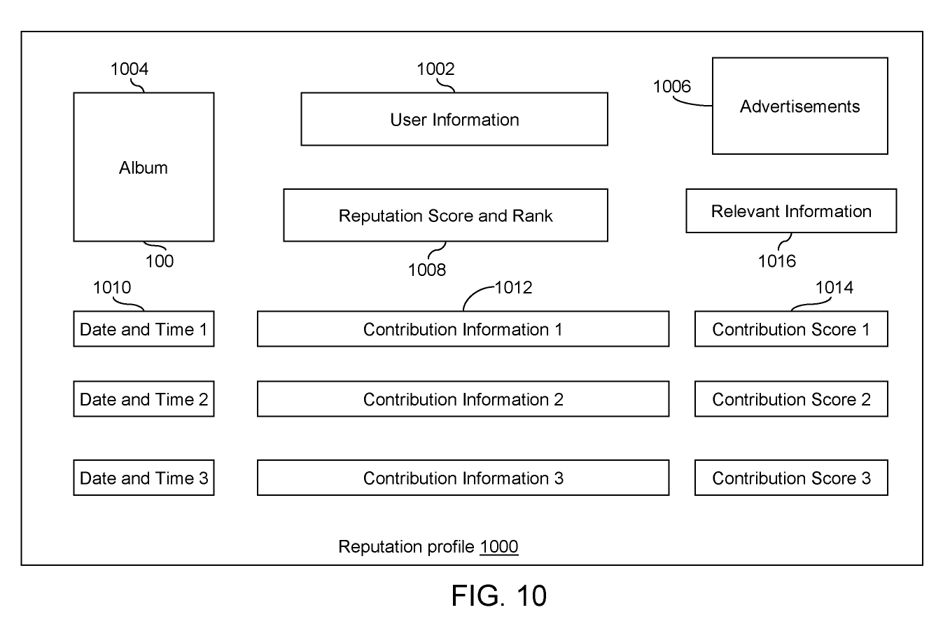

FIG. 10 is an exemplary representation of reputation profile 1000 for a user according to an embodiment of the invention. Reputation profile 1000 comprises user information 1002, photo album 1004 and reputation score 1006. User information 1002 includes information for identifying the user and may include information such as display name, email address, birth date, etc. User information 1002 may also include other information like links to personal website for the user, link to blogs, communities etc. owned by the user and links to favorite blogs for the user.

Photo Album 1004 may have one or more profile pictures of the user. Album 1004 may also have links to other albums of the user. [change in FIG.—1006 and 1008 Discuss the key components of reputation profile first and the optional components later]

Reputation profile 1000 of the user also shows reputation score and the rank 1006 for the user. Reputation score and rank 1006 can be used to predict the quality of contributions made by the user. The method for assigning reputation score and rank has been explained in detail in conjunction with FIG. 5.

In an embodiment of the invention reputation profile 1000 of the user on online community 102 may also have advertisements 1008 posted by external parties. In an embodiment of the invention, advertisements 1006 may be customized based on the profile of the user viewing reputation profile 1000. For example, a real estate agent residing in the US would be shown advertisements related to real estate in the US.

Reputation profile 1000 of the user may also display the date and time 1010 of all the contributions made by the user on online community 102. Reputation profile 1000 also shows the contribution information 1012 for all the contributions. Contribution information 1012 contains brief text description of each of the contribution. Contribution information 1012 also contains information on whether the contribution is a reply, query or a feedback. Contribution information 1012 has been explained in detail in conjunction with FIG. 3. Reputation profile 1000 may also display a contribution score 101 4 for each of the contribution. According to an embodiment of the invention reputation profile 1000 for a user displays all the contributions made by the user on the various online communities where the user participated.

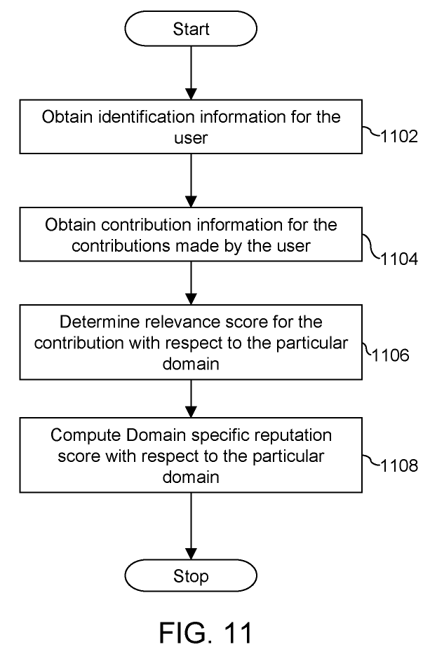

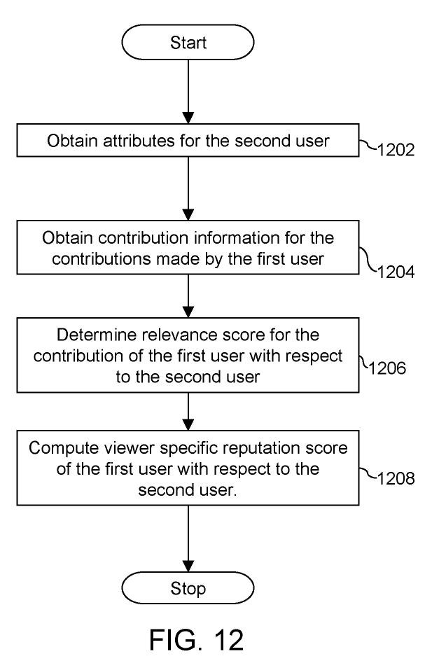

According to another embodiment of the invention, reputation profile 1000 also shows other relevant information 1016. Other relevant information 1016 might include statistics on number of times the user visited particular online community, time spent in the online community and a domain specific reputation score. Domain specific reputation score is an index representing the quality of contribution made by the user in the particular domain. The domain Specific reputation score has been explained in detail in conjunction with FIG. 11. Other relevant information may also include a viewer specific reputation score. Viewer specific reputation score is an index representing the quality of contribution made by the first user as seen by the second user. The viewer specific reputation score has been explained in detail in conjunction with FIG. 12.

FIG. 11 is a flowchart representing a method to evaluate the quality of contribution of a user in a particular domain in accordance with an embodiment of the invention. A domain is broad area or field in which the contribution from a user may be classified. Example of domains can include sports, politics, science, technology, love, astrology and the like. According to an embodiment of the invention, there is a pre-assigned domain classification provided by the community owners. According to another embodiment of the invention, new domains can be added by the community owners or users. At step 1 102, the user is identified on online community 102 on the basis of identification information of the user. The method of obtaining identification information is described in detail in conjunction with FIG. 3 and FIG. 6.

At step 1104, contribution information for the contributions made by the user across multiple online communities 102 is obtained. Contribution information includes all the relevant information related to a contribution made by the user. The contribution information is described in detail in conjunction with FIG. 3.

At step 1106, a relevance score for the contribution with respect to the particular domain is calculated. Relevance score is an index representing the relevance of the contribution with respect to the particular domain. Relevance score can be numerical value, grade, graphical representation and the like. For example, in a blog community, if a user Alice submits a comment regarding the medical benefits of using organic food, then this contribution made by Alice has more relevance score in Medicine domain and food domain than in Technology domain.

According to an embodiment of the invention, relevance score is calculated based on the input provided by other users regarding the relevance of the contribution with respect to a particular domain. For example, in a blog community, users provide input whether a comment submitted in the blog is relevant to politics or not. Based on the inputs provided by the users a relevance score on a scale of 5 is calculated to determine the relevance of the comment with respect to politics.

According to another embodiment of the invention, the relevance score of a contribution is assigned by the community owner.

In another embodiment of the invention the relevance score of a contribution is assigned based on computer generated analysis of the contribution. For example in blog community for politics, the relevance score of a comment is assigned by finding the frequency of a few keywords like politics, republican, democratic, communist and the like. It will be apparent to a person skilled in the art that any other mode of assigning relevance score to a contribution can be used without deviating from the scope of the present invention.

At step 1108, a domain specific reputation score for the user is calculated based on the contribution information of the contributions made by the user across multiple online communities and their relevance score with respect to the particular domain. Domain specific reputation score is an index representing the quality of contribution made by the user in the particular domain. Therefore if a user has high domain specific reputation score with respect to a particular domain then he/she has more credibility in that domain. For example, a user having high domain specific reputation score in the domain of sports would be considered an expert in the same. The calculation of domain specific reputation score is done on the basis of various factors like feedback received for the contributions of the user from other users in the online community, frequency of participation, reputation score of the user providing feedback, consistency shown by the user in providing feedback to other users and the like. These factors and the details on computing the reputation score are discussed in conjunction with FIG. 9.

According to an embodiment of the invention, domain specific reputation scores are calculated for all users across plurality of online communities with respect to each domain. Based on the domain specific reputation score a rank is calculated for a user in a particular domain. In one embodiment, rank for a user in a particular domain is calculated with respect to all users in a single online community. In another embodiment, the rank for the user is calculated with respect to other users across a plurality of online communities. Therefore, a user will have a different domain specific reputation score and rank for each domain, representing his/her expertise in that domain.

According to an embodiment of the invention the domain specific reputation scores and ranks are displayed along with reputation profile 1000 of the user. According to another embodiment of the invention, users are identified based on their viewer specific reputation score and the corresponding ranks in the domain. These users may be given preferential treatment by the online community. For example, a video sharing community can identify a user with highest rank in entertainment and then give this user a specific badge on the profile to signify that the user is the best in sharing videos related to entertainment.

According to another embodiment of the invention, users may be selected for promotion of various products and services in a particular domain. This selection may be made based on the domain specific reputation score. In an embodiment of the invention, the rank of the user in the domain is used for selecting the user. For example, user with the top 10 ranks in technology domain may be approached for promotion of new technology products. According to another embodiment, contributions made by users are shown prominently based on their ranks in the domain. For example, in a blog on technology products, a comment posted by the user having the highest rank in technology is highlighted.

FIG. 12 is a flowchart representing a method to evaluate the quality of contribution made by a first user with reference to a second user in accordance with an embodiment of the invention. Every user has specific interests and preferences on various issues. Therefore, a contribution will have different relevance to a particular user based on the interests and preference of the user. These interests and preferences of the user are stored in user information 1002 and relevant information 1016 as various attributes of the user.

At step 1202, attributes of the second user are obtained. The attributes may be obtained on the basis of identification information of the second user or the statistics of the user participation stored in reputation profile 1000. The attributes may also be a set of user specific information providing indication about user's interests or preferences. Examples of user attribute may include user location, profession, hobbies, favorite movies, favorite music, political inclination, background information, income, sex and the like. According to an embodiment of the invention, these set of attributes are obtained from user specific reputation profile 1000. According to another embodiment of the invention the set of attributes are provided by the user. It will be apparent to person skilled in the art that any other mode of obtaining the set of attributes for a user can be used without deviating from the scope of the invention.

At step 1204, contribution information for the contributions made by the first user across multiple online communities is obtained. Contribution information has all the information available for a contribution made by the first user. The contribution information is described in detail in conjunction with FIG. 3.

At step 1206, a relevance score for the contribution with respect to the second user is calculated. The method of calculating the relevance score is discussed in detail in conjunction with FIG. 11. A high relevance score for a user with respect to a second user indicates that the content posted by the first user is highly relevant to the second user. For example, in a blog community, a user Bob providing contribution about the reviews of movies will have high relevance score with respect to a user Carol having profession attribute as actor.

At step 1208, a viewer specific reputation score for the first user is calculated based on the contribution information of the contributions made by the user across multiple online communities and the relevance score of these contributions with respect to the first user. Viewer specific reputation score is an index representing the quality of contribution made by the first user as seen by the second user. Therefore if the first user has high viewer specific reputation score with respect to the second user then the first user has more credibility for the second user. The calculation of viewer specific reputation score is done on the basis of various factors like feedback received for the contributions of the first user by the second user, frequency of participation, reputation score of the user providing feedback (second user), consistency in providing feedback to others and the like. These factors and the details on computing the reputation score are discussed in conjunction with FIG. 9.

According to an embodiment of the invention, viewer specific reputation scores are calculated for all users across plurality of online communities with respect to each user. According to another embodiment of the invention, ranks of all users are calculated based on the viewer specific reputation score with respect to a particular user. Rank as seen by a particular user can be calculated among all users across plurality of online community or amongst all users in an online community. Therefore, a user will have a different viewer specific reputation score and rank for different users.

According to an embodiment of the invention the viewer specific reputation scores and ranks are used to display the content to a user. According to another embodiment of the invention contributions made by other users are shown to a particular user based on the viewer specific reputation scores of other users across plurality of online communities with respect to the particular user. According to another embodiment of the invention users may be identified based on their viewer specific reputation score with respect to a particular user. For example, in an online dating community, if among all females Alice has highest viewer specific reputation score with respect to Sam then Alice's profile is sent to Sam as the potential partner for dating.

The present invention may be provided as a computer program product which may include a machine-readable medium having stored thereon instructions which may be used to program a computer (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnet or optical cards, or other type of media machine-readable medium suitable for storing electronic instructions. Moreover, the present invention may also be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection).

The methods of the invention may be implemented using computer software. If written in a programming language conforming to a recognized standard, sequences of instructions designed to implement the methods can be compiled for execution on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, application), as taking an action or causing a result. Such expressions are merely a shorthand way of saying that execution of the software by a computer causes the processor of the computer to perform an action or produce a result.

Advantages.

The method and system in accordance with various embodiments of the invention provides several advantages. The invention provides for assessing the quality of a contribution made by a user across online communities. This allows other users of the community to distinguish genuine comments from spam.

The reputation score of a user helps other users to ascertain the credibility of a person providing a contribution. A higher reputation score indicates that the person has greater credibility. The system also maintains a unique reputation profile for a user across distributed online communities. The system also displays the links to all the online communities visited by the user in his/her reputation profile. Public display of such a reputation profile helps in increasing the participation in all the online communities.

The system also provides several verification techniques as described above and hence prevents impersonation. The system also has an additional advantage of showing contribution from the user with higher reputation score prominently. The system also allows identifying the user with the highest reputation score. These users can then be approached to promote other products and services. Hence, overall the system incentivizes each user to contribute more and better content, thereby improving the quality of community discourse.

While example embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

What is claimed is:

1. A computer implemented method for evaluating the quality of contribution of a user, the user making at least one contribution to at least one online community, the reputation profile indicating the quality of a contribution made by the user, each online community comprising a plurality of users, the method comprising:
(a) obtaining identification information for the user;
(b) obtaining contribution information for the at least one contribution made by the user to at least one online community;
(c) analyzing the contribution information;
(d) managing the reputation profile of the user based on the analysis of the contribution information, wherein the reputation profile indicates the quality of contribution of the user; and,
(e) publishing the reputation profile alongside with the user contribution on the online community.

2. The method of claim 1 further comprising a step of validating the user.

3. The method of claim 1 wherein publishing the reputation profile is done in the form of a pop-up on the webpage of the online community.

4. The method of claim 1 wherein the reputation profile comprises records of all the previous contributions made by the user on all the online communities.

5. The method of claim 1 wherein the reputation profile comprises record of all the online communities visited by the user.

6. The method of claim 1 wherein the step of managing the reputation profile of user further comprising updating the reputation profile in case of a new contribution.

7. The method of claim 1 wherein the contribution information is a feedback provided by other users on the contribution.

8. The method of claim 7 further comprising the step of updating the reputation profile in case of a new feedback.

9. The method of claim 1 wherein the reputation profile comprises of a statistics on number of times user visited an online community.

10. The method of claim 9 further comprising the step of pushing sales and other services based on the statistics.

11. A system for evaluating the quality of contribution of a user, the user making at least one contribution to at least one online community, the reputation profile indicating the quality of a contribution made by the user, each online community comprising a plurality of users, the system comprising:
(a) means for obtaining identification information for the user;
(b) means for obtaining contribution information for the at least one contribution made by the user to at least one online community;
(c) means for analyzing the contribution information;
(d) means for managing the reputation profile of the user based on the analysis of the contribution information, wherein the reputation profile indicates the quality of contribution of the user; and,
(e) means for publishing the reputation profile alongside with the user contribution on the online community.

12. A computer program product for use with a computer implemented method for evaluating the quality of contribution of a user, the user making at least one contribution to at least one online community, the reputation profile indicating the quality of a contribution made by the user, each online community comprising a plurality of users, the computer program product comprising a computer usable medium having a computer readable program code embodied therein, the computer program code performing:
(a) obtaining identification information for the user;
(b) obtaining contribution information for the at least one contribution made by the user to at least one online community;
(c) analyzing the contribution information;
(d) managing the reputation profile of the user based on the analysis of the contribution information, wherein the reputation profile indicates the quality of contribution of the user; and,
(e) publishing the reputation profile alongside with the user contribution on the online community.
